(19) United States
(12) Patent Application Publication
(10) Pub. No.: US 2014/0110051 A1
(43) Pub. Date: Apr. 24, 2014

(54) METHOD FOR MAKING A SANDWICH TYPE COMPOSITE BY CO-FIRING

(71) Applicants: Christian Desagulier, Paris (FR); Frédéric Veilleraud, Triel Sur Seine (FR); Florian Lavelle, Paris (FR)

(72) Inventors: Christian Desagulier, Paris (FR); Frédéric Veilleraud, Triel Sur Seine (FR); Florian Lavelle, Paris (FR)

(73) Assignee: ASTRIUM SAS, Paris (FR)

(21) Appl. No.: 14/119,480

(22) PCT Filed: Jun. 12, 2012
(86) PCT No.: PCT/EP2012/061124

§ 371 Date: Nov. 22, 2013

(30) Foreign Application Priority Data
Jun. 14, 2011 (FR) 1155168

(51) Int. Cl. B32B 37/02

(52) U.S. Cl. CPC B32B 37/02
USPC 156/292

(57) ABSTRACT

The invention provides a method for making a composite (10) including two skins (14) of composite material bonded on either side of a core (12) having the form of a honeycomb type panel,
including a step of firing the skins (14) onto the core (12) to simultaneously carry out hardening of the skins (14) and bonding of the skins (14) with the core (12),
characterised in that it consists in placing a rigidifying layer (22) between the core (12) and at least one skin (14).

### TECHNICAL FIELD

The invention provides a method for making a sandwich type composite by co-firing enabling the porosity of materials to be restricted.

The invention enables in particular the so-called telegraphing and expansion phenomena to be restricted.

### STATE OF PRIOR ART

In FIG. 1 is represented a conventional sandwich type composite 10 which consists of an assembly of skins 14 of composite material, consisting for example of fibres and a binder such as a resin, on either side of a centre core 12, having for example a honeycomb type structure by an adhesive film 26.

Making the composite 10 by co-firing enables to perform in a single firing step the hardening of the skins 14 and the assembly thereof onto the core 12 by an adhesive film 26 between each skin and the core, which is hardened also during the firing step.

Such a method enables time to be saved relative to an assembling method for which the skins 14 are fired during a first firing step and they are adhered to the core 12 during a second step of firing an adhesive film 26 between the core 12 and each skin 14.

During the single firing step, the resin binding the fibres to one another and the adhesive film 26 binding the skins to the core simultaneously harden.

This firing step is implemented through a device which includes a lower mould on which the skins and the core 12 are placed to be shaped as the composite 10 to be obtained and which includes a flexible membrane, or bladder, which covers the skins 14 and the core 12 to apply an air vacuum between the bladder and the mould.

The air vacuum then causes a pressure in the bladder and the mould onto the skins 14, tightening them onto the centre core 12.

Under this pressure, the skin 14 contacting the bladder is deformed inwardly of the cells 16 of the core 12, and compounds of the other skin 14, which contact the mould, raise inwardly of the cells 16 of the core 12.

These phenomena, commonly called “telegraphing” for the former and “expansion” for the latter, restrict the mechanical properties of the composite 10 because the fibres of the skins 14 are not all properly oriented, in particular at the end of the cells 16.

To restrict the telegraphing phenomenon, it has been proposed to introduce a pressure distributor plate between the bladder and the adjacent skin.

However, this solution does not enable the telegraphing phenomenon to be completely removed and does not enable the expansion phenomenon to be restricted.

The object of the invention is to provide a method for making a sandwich type composite 10 by co-firing, enabling both the telegraphing phenomenon and the expansion phenomenon to be restricted.

### DISCLOSURE OF THE INVENTION

The invention provides a method for making a composite including two skins of composite material bonded on either side of a core having the form of a honeycomb type panel including cells perpendicular to the main plane of the panel, the method including a step of superimposing the skins and the core onto a mould and a step of firing the skins on the core to simultaneously carry out hardening of the skins and bonding of the skins with the core, characterised in that it consists in placing a rigidifying layer between the core and at least one skin during the step of superimposing the skins and the core, said rigidifying layer being made so as to distribute pressure strains between said at least one associated skin and the core.

The introduction of a rigidifying layer between the core and a skin enables either or both telegraphing and expansion phenomena to be restricted.

Preferably, a rigidifying layer is interposed between the core and each skin during the step of placing the skins.

Preferably, a rigidifying layer is only interposed between the core and the skin which directly lies on the mould.

Preferably, a bladder covers the stack including the core, the skins and the rigidifying layer, and a pressure distributor is arranged between the bladder and the skin (14) located closest to the bladder.

Preferably, the rigidifying layer consists of a pre-fired layer of composite material.

Preferably, the composite has a non-planar shape, and the shape of the rigidifying layer is similar to the final shape of the composite.

Preferably, the rigidifying layer consists of a layer of composite material which is fired during said firing step.

Preferably, the rigidifying layer includes fibres forming a meshing the mesh size of which is lower than the size of the cells of the core.

Preferably, the rigidifying layer is formed from parallel strips of fibres arranged by covering each other.

Preferably, the rigidifying layer is formed from intersected strips of fibres.

### BRIEF DESCRIPTION OF THE DRAWINGS

Further characteristics and advantages of the invention will become clearer upon reading the detailed following description for the understanding of which the appended figures will be referred to, wherein:

FIG. 1 is a cross-section schematic representation of a sandwich type composite obtained according to the state of prior art;

FIG. 2 is a cross-section of the parts of a composite according to the invention, placed on a moulding device before the firing step, wherein two rigidifying layers are incorporated to the stack;

FIG. 3 is a cross-section view similar to that of FIG. 2, wherein a single rigidifying layer is incorporated to the stack.

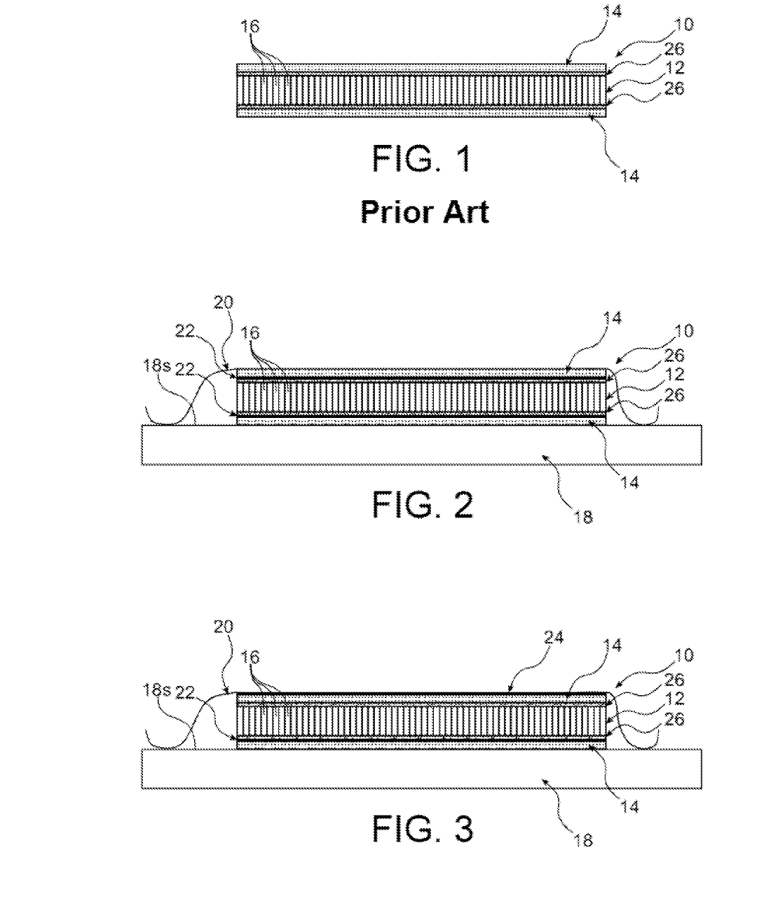

### DETAILED DISCLOSURE OF PARTICULAR EMBODIMENTS

In FIG. 2 are represented elements for forming a sandwich type composite 10, which includes a centre core 12 which is herein planar and horizontal, and two planar skins 14 vertically distributed on either side of the core 12 and bonded to the core 12 by means of an adhesive layer 26.

The core 12 forms a honeycomb type structure, that is it includes a plurality of vertical cells 16 placed side by side. The core 12 is made of a known material, for example a composite material, or even a metal material.

The skins 14 each consist of a layer of composite material.

The composite material making up the skins consists of a reinforcement having the form of continuous or discontinuous fibres enabling the function of strain strength to be ensured and of a matrix, which acts as a binder and which ensures cohesion between the reinforcements so as to distribute mechanical loads.

By way of examples, the composite material is based on carbon fibres, poly-para-phenylene terephthalamide fibres known as “KEVLAR”, glass fibres or even a mixture of glass and aluminum fibres known as “GLARE” (GLAss REinforced).

According to a first embodiment, the fibres are organized as plies of parallel fibres. These plies are arranged by intersecting or covering each other, so as to form several layers making up the skin 14.

According to another embodiment, the fibres are organized so as to form a cloth, and several layers of cloth are superimposed to form the skin 14.

The matrix consists for example of a thermosetting resin.

Making the composite 10 is performed according to a so-called “co-firing” method, that is the firing of the resin forming the matrix of the skins 14 and the firing of an adhesive film 26 used for attaching the skins 14 with the core 12, are performed in one single firing step.

The device used to implement the method for making the composite 10 includes a mould 18 on which the skins 14, the core 12 and the adhesive films 26 are staked, and a bladder 20 which covers the skins 14 and the core 12 and which is attached to the mould 18 in a gas tight manner, such that an air vacuum can be formed in the volume bounded by the mould 18 and the bladder 20, wherein the skins 14, the core 12 and the adhesive films 26 are accommodated.

The mould 18 includes an upper face 18s which is herein planar and horizontal.

It will be understood that the invention is not restricted to this shape of the upper face, which can be of any type, according to the desired shape of the composite 10. The upper face 18s of the mould 18 can thus be curved, be concave or convex.

According to a first step of the method for making the composite 10, the skins 14, the core 12 and the adhesive films 26 are successive stacked onto the upper face 18s of the mould 18.

Then, the bladder 20 is attached to the mould 18, by covering the sandwich formed by the skins 14 and the core 12.

An air vacuum is formed between the bladder 20 and the mould 18, to press the skins 14 and the core 12 against the upper face 18s of the mould 18 and thus impart them the shape of the mould which is the desired shape of the composite 10 to be obtained.

Then, the assembly is positioned in an oven (not represented) to make the single step of firing the skins 14, the core 12 and the adhesive films 26, called co-firing step, so as to obtain the composite 10 at the end of this single firing step.

The depression, or air vacuum, formed into the mould 18 and the bladder 20 enables the skins 14 to be maintained vertically pressing against the core 12.

To reduce the telegraphing and expansion risks, that is fibres and/or adhesive do not penetrate inside the cells 16 of the core 12, the method according to the invention consists in introducing a rigidifying layer 22 between each skin 14 and the core 12 during the step of placing the skins and the core 12 onto the mould.

This rigidifying layer 22 is thus incorporated to the composite 10 and is part of its structure. The rigidifying layer thus provides properties, in particular mechanical and/or thermal properties to the composite 10. It is consequently designed as a function of the desired mechanical or thermal properties of the composite 10.

The rigidifying layer 22 is designed so as to partly seal the cells 16 of the core 12, while resin enabling each skin 14 to be attached to the core 12 passes therethrough.

Moreover, the rigidifying layer 22 distributes vertical pressure between the associated skin 14 and the core 12 throughout the surface of the rigidifying layer 22, thus this pressure is not concentrated at the wall ends of the cells 16. The pressure at each contact point between a skin 14 and the associated rigidifying layer 22 is thus restricted, which restricts expansion and telegraphing phenomena.

According to an embodiment of the invention, the rigidifying layer 22 is made of composite material, similar to the skins 14 and includes a reinforcement and a matrix.

The rigidifying layer 22 is conventionally made, it can thus consist of a single piece cloth, or be made from a plurality of strips, arranged in parallel and covering each other, or intersected.

The rigidifying layer 22 is on the other hand fired beforehand, during a firing step separated from the abovementioned steps. Thus, the rigidifying layer 22 has already been hardened, such that it does not deform under the effect of the pressure of the associated skin 14 onto the core 12.

This step of firing the rigidifying layer 22 does not consequently lengthen the duration of the method, therefore there is no waste of time caused by the production of the rigidifying layer 22.

When the composite 10 is not of planar shape, the rigidifying layer 22 is shaped upon firing, in a shape complementary to the final shape of the composite 10 and the shape of the upper face 18s of the mould 18.

The rigidifying layer 22 can thus be made of metal, for example it consists of a metal meshing.

According to another aspect, when the rigidifying layer 22 consists of a meshing for example a metal meshing, the meshing size is determined as a function of the dimension of the cells 16 of the core 12.

Preferably, the mesh size of the rigidifying layer 22 is lower than the size of the cells 16, so as to at least partly seal the end of each cell 16, thus preventing the associated skin 14 from being deformed inwardly of each cell 16.

According to an alternative embodiment, the rigidifying layer 22 is shaped and fired during the co-firing operation.

According to this alternative embodiment, the resin making the rigidifying layer 22 also ensures the connection of the rigidifying layer 22 to the core 12 and to the associated skin 14. This enables the adhesive layer 26 to be reduced, or even taken out.

According to the embodiment represented in FIG. 2, the composite 10 includes two rigidifying layers 22 which are distributed on either side of the core 12.

According to another embodiment according to the invention, the composite 10 includes a single rigidifying layer 22 which is arranged on a single side of the core 12.

As represented in FIG. 3, the rigidifying layer 22 is arranged between the core 12 and the lower skin 14, that is the skin which is directly lying on the upper face 18s of the mould 18. This rigidifying layer 22 enables the upflow of material into the cells, that is the expansion phenomenon, to be restricted.

To restrict the telegraphing phenomenon, a pressure distributor 24 is interposed between the bladder 20 and the upper skin 14, which is closest to the bladder 20.

This pressure distributor 24 is not part of the final composite 10, which restricts the weight and structure of the composite 10 and does not influence the mechanical behaviour of the composite 10.

According to an alternative embodiment, the rigidifying layer 22 is arranged between the core 12 and the upper skin 14, that is the skin in contact with the bladder 20.

What is claimed is:

1. A method for making a composite (10) including two skins (14) of composite material bonded on either side of a core (12) having the form of a honeycomb type panel including cells (16) perpendicular to the main plane of the panel,
the method including a step of superimposing the skins (14) and the core (12) onto a mould (18) and a step of firing the skins (14) on the core (12) to simultaneously carry out hardening of the skins (14) and bonding of the skins (14) with the core (12),
characterised in that it consists in placing a rigidifying layer (22) between the core (12) and at least one skin (14) during the step of superimposing the skins (14) and the core (12), said rigidifying layer (12) being made so as to distribute pressure strains between said at least one associated skin (14) and the core (12).

2. The method according to claim 1, characterised in that a rigidifying layer (22) is interposed between the core (12) and each skin (14) during the step of placing the skins (14).

3. The method according to claim 1, characterised in that a rigidifying layer (22) is only interposed between the core (12) and the skin (14) which directly lies on the mould (18).

4. The method according to claim 3, wherein a bladder (20) covers the stack including the core (12), the skins (14) and the rigidifying layer (22), characterised in that a pressure distributor (24) is arranged between the bladder (20) and the skin (14) located closest to the bladder (20).

5. The method according to claim 1, characterised in that the rigidifying layer (22) consists of a pre-fired layer of composite material.

6. The method according to claim 5, wherein the composite (10) has a non-planar shape, characterised in that the shape of the rigidifying layer (22) is similar to the final shape of the composite (10).

7. The method according to claim 1, characterised in that the rigidifying layer (22) consists of a layer of composite material which is fired during said firing step.

8. The method according to claim 5, characterised in that the rigidifying layer (22) includes fibres forming a meshing the mesh size of which is lower than the size of the cells (16) of the core (12).

9. The method according to claim 1, characterised in that the rigidifying layer (22) is formed from parallel strips of fibres arranged by covering each other.

10. The method according to claim 1, characterised in that the rigidifying layer (22) is formed from intersected strips of fibres.
